(19) United States
(12) Patent Application Publication
(10) Pub. No.: US 2015/0221302 A1
(43) Pub. Date: Aug. 6, 2015

(54) DISPLAY APPARATUS AND METHOD FOR CONTROLLING ELECTRONIC APPARATUS USING THE SAME

(71) Applicant: SAMSUNG ELECTRONICS CO., LTD., Suwon-si (KR)

(72) Inventors: Sang-jin HAN, Gunpo-si (KR); Eun-hee PARK, Guri-si (KR)

(73) Assignee: SAMSUNG ELECTRONICS CO., LTD., Suwon-si (KR)

(21) Appl. No.: 14/567,195

(22) Filed: Dec. 11, 2014

(30) Foreign Application Priority Data
Feb. 6, 2014 (KR) 10-2014-0013708

(51) Int. Cl. G10L 15/08; G06F 3/044; G10L 17/22

(52) U.S. Cl. CPC G10L 15/08; G10L 17/22; G06F 3/044

(57) ABSTRACT

A display apparatus is provided. The display apparatus includes a microphone configured to receive a voice signal, a voice recognizer configured to recognize a user's voice from the voice signal input through the microphone, a communicator configured to communicate with an electronic apparatus, a storage configured to store information regarding a search command to search the electronic apparatus, and a controller configured to, in response to the search command being included in the user's voice, control to transmit a control signal to generate a feedback signal to the electronic apparatus through the communicator so that the electronic apparatus generates the feedback signal. Accordingly, a user convenience can be improved.

### CROSS-REFERENCE TO RELATED APPLICATIONS

This application claims priority from Korean Patent Application No. 10-2014-0013708, filed in the Korean Intellectual Property Office on Feb. 6, 2014, the disclosure of which is incorporated herein by reference in its entirety.

### BACKGROUND

1. Field

Methods and apparatuses consistent with the exemplary embodiments relate to a display apparatus and a method for searching for an electronic apparatus, and controlling an electronic apparatus using the same, and more particularly, to a display apparatus which performs voice recognition and motion recognition and a method for searching for an electronic apparatus, and controlling an electronic apparatus using the same.

2. Description of the Related Art

A display apparatus refers to an apparatus which displays image information, and main examples of a display apparatus include a television, monitor, etc. However, a display apparatus also includes all apparatuses which receive an image signal from an external source and display the same, or which display an image signal stored in the apparatuses. A display apparatus not only provides a viewer with a three-dimensional (3D) image, but also provides various functions in association with various electronic apparatuses, depending on the advancement of technologies.

A user who watches a display apparatus generally uses a remote controlling device, such as a remote controller which is an electronic apparatus, in order to control the display apparatus. However, at certain times, the remote controller may be become misplaced or lost, therefore causing inconvenience to users.

### SUMMARY

An aspect of the exemplary embodiments relates to a display apparatus which performs voice recognition and motion recognition, and a method for searching for or controlling various apparatuses remotely using the same.

According to an exemplary embodiment, there is provided a display apparatus which includes a microphone configured to receive a voice signal, a voice recognizer configured to recognize a user's voice from the voice signal input through the microphone, a communicator configured to communicate with an electronic apparatus, a storage configured to store information regarding a search command to search for the electronic apparatus, and a controller configured to, in response to the search command being included in the user's voice, control to transmit a control signal to the electronic apparatus through the communicator requesting the electronic apparatus to generate a feedback signal, and generating, by the electronic apparatus, the feedback signal based on the control signal.

According to an aspect of the exemplary embodiment, the microphone and the voice recognizer may remain in an active state when the display apparatus is turned off, and the controller, in response to the user's voice being recognized by the voice recognizer while the display apparatus is turned off, determines whether the search command is included in the user's voice, and when the search command is included in the user's voice, activates the communicator to transmit the control signal to the electronic apparatus.

The controller, in response to a control command to control the display apparatus being included in the voice, turns on the display apparatus and performs a control operation corresponding to the control command.

The communicator performs communication with the electronic apparatus according to one of WiFi and Bluetooth communication methods.

The apparatus may further include at least one button, and the controller, in response to the at least one button being selected, executes a function which matches the at least one button, and in response to the at least one button being selected more than a predetermined number of times for a predetermined time, transmits the control signal to the electronic apparatus through the communicator.

The apparatus further includes a camera, and a motion recognizer configured to recognize a user's motion from an image captured by the camera, and the controller, when the user's motion is a motion to search for the electronic apparatus, may transmit the control signal to the electronic apparatus.

The apparatus may further include a display and a camera configured to perform an image capture process, and the controller, when the search command is included in the user's voice, is configured to transmit the control signal to the electronic apparatus, and the controller is configured to estimate a location of the electronic apparatus by analyzing an image photographed at a time when the display apparatus is used for the last time, and display a user interface (UI) message indicating the estimated location of the electronic apparatus on the display.

According to an aspect of the exemplary embodiment, the apparatus further includes a display, and the communicator is configured to receive location information from the electronic apparatus, the controller, is configured to, when the search command is included in the user's voice, transmits the control signal to the electronic apparatus, and the controller is configured to estimate a location of the electronic apparatus by analyzing an image photographed when the display apparatus is used for the last time, and display a user interface (UI) message indicating the estimated location of the electronic apparatus on the display.

The controller, is configured to, when a control command to control an external electronic apparatus is included in the user's voice, transmit a control signal corresponding to the control command to the external electronic apparatus through the communicator.

According to another exemplary embodiment, there is provided, a method for controlling an electronic apparatus with a display apparatus, the method includes receiving a voice signal, recognizing a user's voice from the inputted voice signal, and when a search command is included in the recognized user's voice, transmit a control signal to the electronic apparatus requesting the electronic apparatus to generate a feedback signal, and generating, by the electronic apparatus the feedback signal based on the control signal.

The receiving a voice signal and the recognizing the user's voice includes, when the display apparatus is in an active state when the display apparatus is turned off, and the user's voice is recognized when the display apparatus is turned off, determining whether the search command is included in the user's voice, and in response to the search command being included in the user's voice, transmitting the control signal to the electronic apparatus.

The method may include, when a control command to control the display apparatus is included in the user's voice, turning on the display apparatus and performing a control operation corresponding to the control command.

The method may include performing communication with the electronic apparatus according to one of WiFi and Bluetooth communication methods.

The display apparatus may further include at least one button, and the method includes, when the at least one button is selected, executing a function corresponding to the at least one button, and when the at least one button is selected more than a predetermined number of times for a predetermined time, transmitting the control signal to the electronic apparatus through the communicator.

The display apparatus may further include a camera, and the method includes recognizing a user motion from an image captured by the camera, and in response to the user motion being a motion to search the electronic apparatus, transmitting the control signal to the electronic apparatus.

The method further includes performing a photographing operation, in response to the search command being included in the user's voice, transmitting the control signal to the electronic apparatus, and estimating a location of the electronic apparatus by analyzing an image photographed when the display apparatus was last used, and displaying a user interface (UI) message indicating the estimated location.

The method may further include receiving location information from a control apparatus, when the search command is included in the user's voice, transmitting the control signal to the electronic apparatus, and estimating a location of the electronic apparatus based on the location information and displaying a UI message indicating the estimated location.

The method may include, when a control command to control an external electronic apparatus is included in the user's voice, transmitting a control signal corresponding to the control command to the external electronic apparatus.

According to the various exemplary embodiments, various apparatuses may be searched for or controlled remotely using a display apparatus which recognizes a user's voice, etc. and thus, the efficiency of apparatus and user convenience can be improved.

### BRIEF DESCRIPTION OF THE DRAWINGS

The above and/or other aspects of the exemplary embodiments will be more apparent by describing certain exemplary embodiments with reference to the accompanying drawings, in which:

FIG. 1 is a block diagram illustrating a display apparatus according to an exemplary embodiment;

FIG. 2 is a view illustrating an example of searching an electronic apparatus using a display apparatus according to an exemplary embodiment;

FIG. 3 is a view illustrating another example of searching an electronic apparatus using a display apparatus according to an exemplary embodiment;

FIG. 4 is a block diagram illustrating a display apparatus according to another exemplary embodiment;

FIG. 5 is a view illustrating yet another example of searching an electronic apparatus using a display apparatus according to an exemplary embodiment;

FIG. 6 is a view illustrating yet another example of searching an electronic apparatus using a display apparatus according to an exemplary embodiment;

FIG. 7 is a view illustrating an example of controlling various apparatuses using a display apparatus according to an exemplary embodiment; and

FIG. 8 is a flowchart for searching an electronic apparatus using a display apparatus according to an exemplary embodiment.

### DETAILED DESCRIPTION OF EXEMPLARY EMBODIMENTS

It should be observed the method steps and system components have been represented by conventional symbols in the figure, showing only specific details which are relevant for an understanding of the present disclosure. Further, details may be readily apparent to person ordinarily skilled in the art may not have been disclosed. In the present disclosure, relational terms such as first and second, and the like, may be used to distinguish one entity from another entity, without necessarily implying any actual relationship or order between such entities.

In the following description, the same drawing reference numerals are used for the same elements even in different drawings. The matters defined in the description, such as detailed construction and elements, are provided to assist in a comprehensive understanding of the exemplary embodiments. Thus, it is apparent that the exemplary embodiments can be carried out without those specifically defined matters. Also, well-known functions or constructions are not described in detail since they would obscure the exemplary embodiments with unnecessary detail.

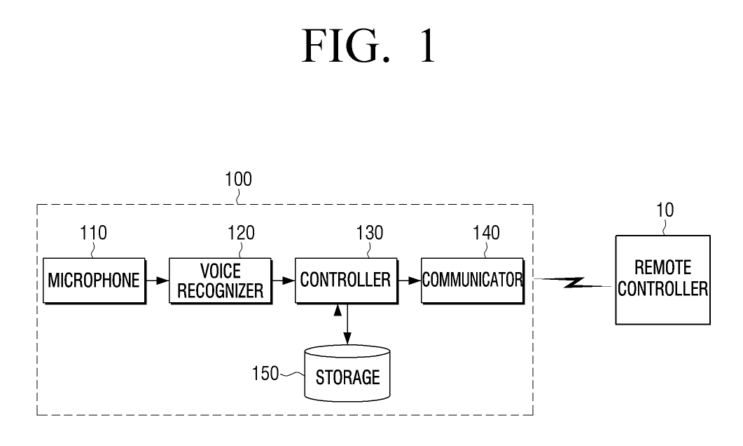

FIG. 1 is a block diagram illustrating a display apparatus according to an exemplary embodiment.

According to FIG. 1, a display apparatus 100 includes a microphone 110, a voice recognizer 120, a controller 130, a communicator 140, and a storage 150.

The display apparatus 100 provides a broadcast which is received via cable or wirelessly to a user through a display (not shown). In addition, the display apparatus 100 may not only provide an external input received from an external apparatus which is connected via cable or wirelessly to a user through a display (not shown), but may also play a file stored in the internal storage medium (video file, still image file, music file, etc.) to provide the file to a user.

The display apparatus 100 may receive and output a broadcast signal, and may be realized as a digital television. However, the display apparatus 100 is not limited thereto, and may be any apparatus which can receive a broadcast signal. For example, the display apparatus 100 may be realized as mobile phone, PMP, MP3, PC, etc.

The microphone 110 may receive a voice signal of a user. The microphone 110 is not limited to any particular microphone, and may be realized as any general microphone.

The voice recognizer 130 recognizes a voice from a voice signal input from the microphone 110. Herein, the microphone 110 and the voice recognizer 120 may be maintained in an active state even if the display apparatus 100 is turned off. Specifically, the microphone 110 and the voice recognizer 120 may be built in a module which operates with low power even if the display apparatus 100 is turned off, such as a camera module (not shown) of the display apparatus 100.

The controller 130 may search for and determine whether a search command to search for the electronic apparatus 100 is included in a voice which is recognized through the voice recognizer 120.

In this case, if a search command to search for the electronic apparatus 10 is included in the voice recognized through the voice recognizer 120, a corresponding control signal may be transmitted to the electronic apparatus 10 through the communicator 140. Herein, the control signal is a signal to generate a feedback signal of the electronic apparatus 10. For example, when a user's voice to search for the electronic apparatus 10 is recognized, the display apparatus 100 may transmit a corresponding control signal to the electronic apparatus 10. Herein, the control signal is a signal to generate a feedback signal from the electronic apparatus 10. The feedback signal may be a signal to generate a sound, for example, a beeping sound, or a vibration.

In addition, if a voice is recognized by the voice recognizer 120 while the display apparatus 100 is turned off, the controller 130 may determine whether a search command is included in the user's voice. Specifically, the controller 130 may be disposed in a module which operates with low power even if the display apparatus 100 is turned off, such as a camera module (not shown) of the display apparatus 100.

In this case, if a search command is included in the recognized voice, a control signal may be transmitted to the electronic apparatus 10 by activating the communicator 140 which will be described later.

If a control command to control the display apparatus 100 is included in the voice which is recognized through the voice recognizer 120, the controller 130 may turn on the display apparatus 100 and perform a control operation corresponding to the control command.

In this case, the controller 130 does not transmit a control signal to the remote controller 10 through the communicator 140 which will be described later.

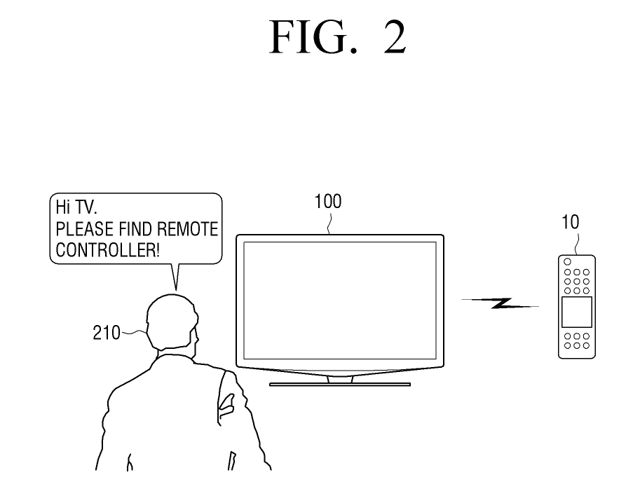

The communicator 140 communicates with the electronic apparatus 10. The communication operation will be described later with reference to FIG. 2.

The storage 150 stores information regarding a search command to search the electronic apparatus 10. Herein, the storage 120 may be realized as DDR, RAM, ROM, flash memory, CD/DVD, etc.

The electronic apparatus 10 transmits the content of a user manipulation to control the operation of the display apparatus 100. To do so, the electronic apparatus 10 may include a power button, a number button, a channel search button (channel-up button/channel-down button), and a volume control button, and may be realized as a touch screen.

FIG. 2 is a view illustrating an example of searching for an electronic apparatus using a display apparatus according to an exemplary embodiment.

According to FIG. 2, the display apparatus 100 receives a voice signal of a user 210 through the microphone 110. The voice recognizer 120 recognizes a voice from the voice signal input through the microphone 110. Herein, it is assumed that the user 210 utters “Hi, TV, please find a remote controller”.

In this case, if a search command is included in the voice uttered by the user 210, the controller 130 transmits, through the communicator 140, a control signal to the electronic apparatus 10, requesting the electronic apparatus 10 to generate a feedback signal. The electronic apparatus generates the feedback signal based on the control signal.

Herein, the search command included in the voice is “Hi, TV, please find a remote controller”. The controller 130 of the display apparatus 100 may determine whether a search command is included in the voice signal. In particular, the controller 130 may operate even though the display apparatus 100 is turned off, and activates the communicator 140 in order to transmit a control signal to the electronic apparatus 10 through the communicator 140. The control signal transmitted to the electronic apparatus 10 is a control signal requesting the electronic apparatus 10 to generate a feedback signal as described above. Herein, the feedback signal may be a signal to generate a beeping sound, or a vibration, etc., but this is only an example. The above-described feedback signal may be any signal which generates an identification mark to allow the user 210 or the display apparatus 100 to identify the electronic apparatus 10.

The operation process of the controller 130 activating the communicator 140 will be described. The communicator 140 and the electronic apparatus 10 may communicate with each other using various communication methods.

The operation process of the display apparatus 100 and the electronic apparatus 10 communicating with each other using Bluetooth when the display apparatus 100 is turned off will be described.

The controller 130 determines that a search command of the user 210, for example, “Hi, TV, please find a remote controller”, is input. As described above, the controller 130 may operate with low power. The controller 130 determines a search command and activates the communicator 140. Herein, the search command “Hi, TV, please find a remote controller”, can be stored in the storage 140. The controller 130 performs Bluetooth pairing with the electronic apparatus 10 using the activated communicator 140. In this case, the display apparatus 100 and the electronic apparatus 10 include a Bluetooth module. When the Bluetooth pairing is completed, the controller 130 generates a control signal corresponding to “please find a remote controller”, and transmits the control signal to the electronic apparatus 10 through the communicator 140. The control signal transmitted from the controller 130 is a signal requesting the electronic apparatus 10 to generate a feedback signal. In this case, the electronic apparatus 10 may generate a sound, for example, a beeping sound or a vibration. The user 210 may identify the location of the electronic apparatus 10 through the sound or vibration generated from the electronic apparatus 10.

Subsequently, the operation process of the display apparatus 100 and the electronic apparatus 10 communicating with each other using WiFi when the display apparatus 100 is turned off will be described.

The display apparatus 100 and the electronic apparatus 10 communicate with each other using a WiFi module in each of the apparatuses, respectively. The display apparatus 100 and the electronic apparatus 10 communicate with each other using a general WiFi communication method. However, the controller 130 may disable the WiFi module when the Bluetooth is turned on. Herein, it is described that the controller 130 disables the WiFi module when Bluetooth is turned on, but the controller 130 may also disable Bluetooth when WiFi is turned on. In the exemplary, only the case where the power of the display apparatus 100 is turned off is described, but operations are performed normally even if the power of the display apparatus 100 is turned on.

In the above exemplary embodiment, the search command is one sentence of “Hi, TV, please find a remote controller”, but “Hi, TV” may be categorized as a search command, and “please find a remote controller” may be categorized as a control command. In this case, “Hi, TV” may function as a search command which is operable even when the display apparatus 100 is turned off. That is, “Hi, TV” may be defined as a search command to communicate with an external apparatus (not shown), and a control command, such as “please find a remote controller” may be stored in the storage 140. The controller 130 may determine a control command stored in the storage 140, generate a control command corresponding to the control command in an external apparatus (not shown) corresponding to the control command, and transmit the control command to the external apparatus through the communicator 140.

If a control command to control the display apparatus 100 is not included in the voice recognized through the voice recognizer 140, the controller 130 may turn on the display apparatus 100 and perform a control operation corresponding to the control command.

For example, when it is assumed that “Hi, TV” is a search command to search an external apparatus, and a user utters a voice control command of “Power on”, the controller 130 may turn on the display apparatus 100 without controlling the external apparatus (not shown) as “Hi, TV” which is a search command to search an external apparatus, is not included. The display apparatus 100 may also be configured not to respond to a voice command.

The display apparatus 100 according to another exemplary embodiment may communicate with electronic apparatuses other than a remote controller. The display apparatus 100 may search for a mobile apparatus and other electronic apparatuses which may perform communication with the display apparatus, in addition to a remote controller.

Further, the display apparatus 100 may update software and firmware of electronic apparatuses which may perform communication. Specifically, the controller 130 may transmit an update control signal including pre-stored update information to an external mobile apparatus though a user manipulation such as a user's voice, and the mobile apparatus may be provided with software, firmware, etc. included in the update control signal from the display apparatus 100 and perform the update operation.

The display apparatus 100 may provide an audio input to an external electronic apparatus. The controller 130 may provide a pre-stored audio to an external electronic apparatus through a user manipulation such as a user's voice. In this case, the display apparatus 100 includes a module to play and encode/decode the audio. The display apparatus 100 may also receive an audio from an external apparatus.

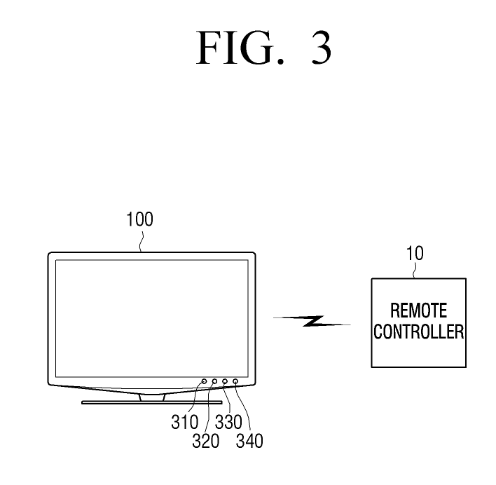

FIG. 3 is a view illustrating another example of searching for an electronic apparatus using a display apparatus according to an exemplary embodiment.

According to FIG. 3, the display apparatus 100 includes a plurality of buttons 310-340.

The plurality of buttons 310-340 may be a volume control button, a channel selection button, etc., but are not limited thereto.

Each of the plurality of buttons 310-340 corresponds to respective functions performed by the display apparatus 100. For example, a channel up button performs a channel up operation, and a volume down button performs a volume down operation.

In this case, if a button of the display apparatus 100 is selected more than a predetermined number of times for a predetermined time period, the controller 130 may transmit a control signal to the electronic apparatus 10 through the communicator 140. As described above, the control signal is a signal requesting the electronic apparatus 10 to generate a feedback signal. Ultimately, the controller 130 transmits a control signal which is reserved by the pattern of button selection to the electronic apparatus 10.

For example, the controller 100 may activate the communicator 140 when button 1 (310), button 2 (320), button 3 (330), and button 4 (340) are selected simultaneously, and transmit the control signal to the electronic apparatus 10 through the communicator 140. If a button is selected 5 times in a row for 3 seconds, the controller 130 may determine that it is a command to search for an electronic apparatus, and may transmit a control signal to the electronic apparatus as described above, but this is only an example. The controller 130 may store various button selection patterns in the storage 150, and if a button selection pattern occurs, the controller 130 may transmit a control signal to the electronic apparatus 10.

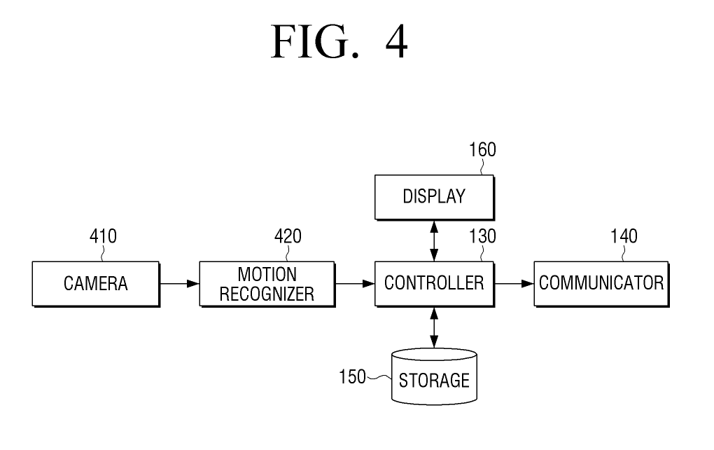

FIG. 4 is a block diagram illustrating a display apparatus according to another exemplary embodiment.

The display apparatus 100 may include a camera 410, a motion recognizer 420, the controller 130, the communicator 140, the storage 150, and a display 160.

The camera 410 may be provided in the display apparatus 100, and may photograph an image. Herein, the camera 410 may operate with low power.

The motion recognizer 420 may recognize a user's motion from the image photographed by the camera 410.

If the user's motion is a motion to search for the electronic apparatus 10, the controller 130 may transmit a control signal to the electronic apparatus 10. In this case, the controller 130 may store a control command corresponding to the motion to search for the electronic apparatus 10 in the storage 150. In addition, the controller 130 may determine whether the motion recognized by the motion recognizer 420 corresponds to the control command stored in the storage 150. When a motion to search for the electronic apparatus 10 corresponds to the motion recognized through the motion recognizer 420, the controller 130 may transmit a corresponding control signal to the electronic apparatus 10.

The display 160 displays an image signal. Herein, the display 160 displays a display screen according to a command from the controller 130.

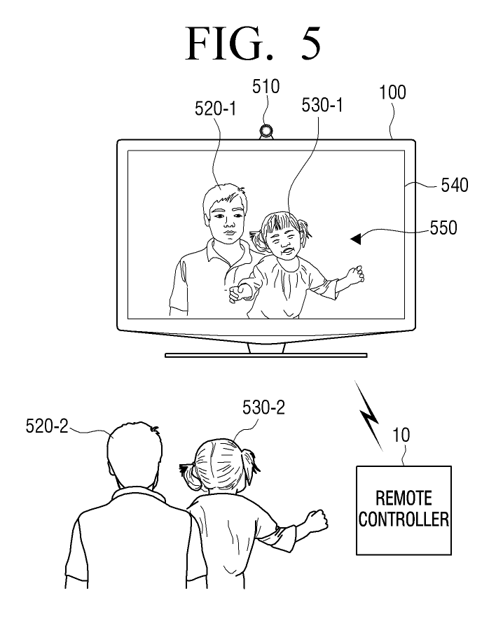

FIG. 5 is a view illustrating yet another example of searching an electronic apparatus using a display apparatus according to an exemplary embodiment.

According to FIG. 5, the display apparatus 100 includes a camera 510 which performs image capture processes. As described above, if a search command is included in a user's voice, the controller 130 transmits a control signal to the electronic apparatus 10. In this case, the location of the electronic apparatus 10 may be estimated by analyzing an image which is photographed when the display apparatus 100 was last used, and a UI message indicating the estimated location of the electronic apparatus 10 may be displayed on a display 540.

Specifically, the display apparatus 100 transmits a control signal to the electronic apparatus 10 through the controller 130 and the communicator 140 right before the power of the display apparatus 100 is turned off. In addition, the controller 130 may analyze the location of the electronic apparatus 10 through a feedback signal received from the electronic apparatus 10, and the controller 130 may photograph an image through the camera 510. The controller 130 may reflect location coordinates including the photographed image and the location of the electronic apparatus 10 on the photographed image. The above description is to calculate the location coordinates of the electronic apparatus 10, but the location of the electronic apparatus 10 may be specified only through image photographing. Subsequently, if a search command to search for the electronic apparatus 10 is included in the user's voice, the controller 130 may display an image including the location of the electronic apparatus 10 stored in the storage 150 on the display 540 of the display apparatus 100 in order to identify the location of the electronic apparatus 100.

Herein, images 520-1, 530-1 on the display 540 are images photographed by the display apparatus 100 through the camera 510, which photograph objects 520-2, 530-2 who watch the display apparatus 100.

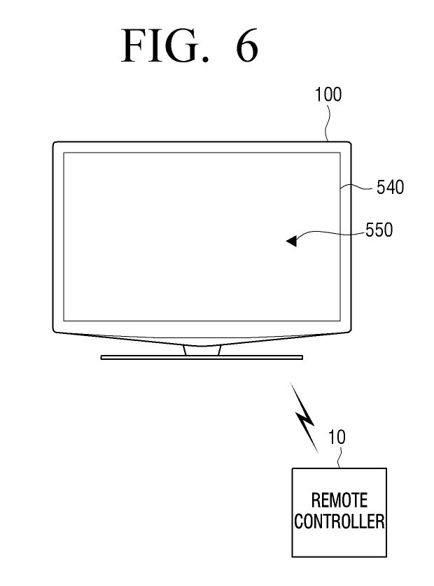

FIG. 6 is a view illustrating yet another example of searching for an electronic apparatus using a display apparatus according to an exemplary embodiment.

According to FIG. 6, the communicator 150 of the display apparatus 100 may receive location information from the electronic apparatus 10. If a search command is included in a voice, the controller 130 may transmit a control signal to the electronic apparatus. The controller 130 estimates the location of the electronic apparatus 10 based on the above-described location information, and the display apparatus 100 displays a UI message indicating the estimated location on the display 540.

Specifically, the display apparatus 100 transmits a control signal to the electronic apparatus 10 through the controller 130 and the communicator 140 right before the power of the display apparatus 100 is turned off. The controller 130 may analyze location information of the electronic apparatus 10 by communicating with the electronic apparatus 10 through the communicator 140. For example, the electronic apparatus 10 may have infra-red (IR) sensors, gyro sensors, acceleration sensors, GPS, geomagnetic sensors, etc. so that the controller 130 can analyze the location information of the electronic apparatus 10.

The display apparatus 100 displays location information 550 of the electronic apparatus 10 through the display 540.

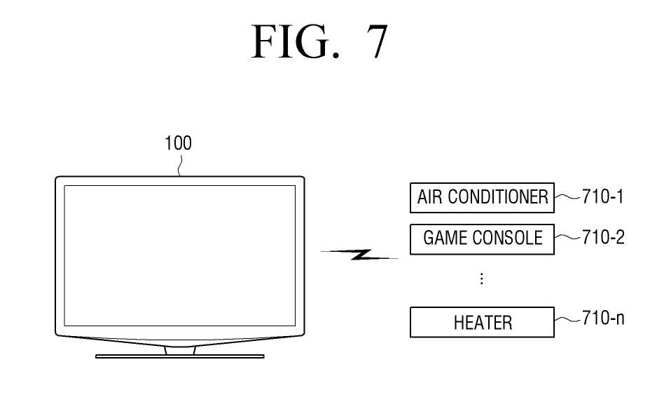

The display apparatus 100 may control an external apparatus, which will be described with reference to FIG. 7.

FIG. 7 is a view illustrating an example of controlling various apparatuses using a display apparatus according to an exemplary embodiment.

According to FIG. 7, the display apparatus 100 may transmit a control command to control various external apparatuses 710-1˜710-n to the various external apparatuses 710-1˜710-n. If a control command to control external apparatuses 710-1˜710-n is included in a user's voice, the controller 130 may transmit a control signal corresponding to the control command to the various external electronic apparatuses through the communicator 140. The external electronic apparatuses 710-1˜710-n may be an air conditioner 710-1, a game console 710-2, and a heater 710-n, but this is only an example. The controller 130 may transmit a control command to various other external electronic apparatuses.

For example, if a user's voice utterance “please, turn on the air conditioner” is input through the voice recognizer 120 of the display apparatus 100, the controller 130 determines whether a control command to control the air conditioner 710-1 is included. If a control command is included, the controller 130 transmits a control command signal to the air conditioner 710-1 so that the power of the air conditioner is turned on and the air conditioner 710-1 can operate.

In addition, the display apparatus 100 may transmit a control signal to update software, firmware, etc. of the external apparatuses 710-1˜710-n, and the external apparatuses 710-1˜710-n may download firmware, software, etc. included in the update control signal and perform the updating. Further, the display apparatus 100 may provide the external apparatuses 710-1˜710-n with audio. The external apparatuses 710-1˜710-n which receive the audio may store and play the audio.

The exemplary embodiment does not include description regarding general elements of a display apparatus, such as a tuner module, but it is assumed that the display apparatus 100 includes all elements which are essential to a display apparatus. In addition, the display apparatus 100 may include all of LCD, LED, OLED, and plasma display apparatus.

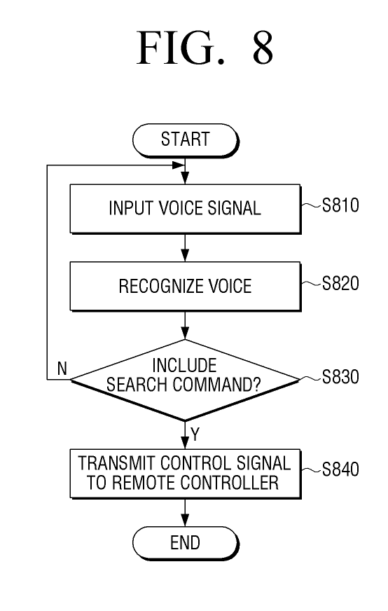

FIG. 8 is a view illustrating an example of controlling various apparatuses using a display apparatus according to an exemplary embodiment.

According to FIG. 8, a display apparatus receives a voice signal (operation S810). Subsequently, a voice is recognized from the inputted voice signal (operation S820). The voice is generally a user's voice, but is not limited thereto.

If a search command is included in the user's voice (operation S830), a control signal to request the electronic apparatus to generate a feedback signal is transmitted to the electronic apparatus (operation S840) so that the electronic apparatus generates the feedback signal.

In addition, operations such as maintaining the display apparatus in an active state even if the display apparatus is turned off, when a user's voice is recognized while the display apparatus is turned off, determining whether a search command is included in the user's voice, and if a search command is included in the user's voice, transmitting a control signal to the electronic apparatus may be further included.

If a control command to control the display apparatus is included in the user's voice, the display apparatus may be turned on, and a control operation corresponding to the control command may be performed.

Herein, the display apparatus may perform communication with the electronic apparatus according to one of WiFi and Bluetooth communication methods. The specific operation method has been described above with reference to FIG. 2, so further description will not be provided.

There may be other exemplary embodiments of controlling an electronic apparatus using a display apparatus.

Specifically, the display apparatus may further include at least one button. If the at least one button is selected, a function corresponding to the selected button is executed, and if a button is selected more than a predetermined number of times for a predetermined time period, a control signal may be transmitted to the electronic apparatus. The operation method thereof has been described above with reference to FIG. 3, so a further description will not be provided.

Below is the description regarding another exemplary embodiment of controlling an electronic apparatus using a display apparatus.

Specifically, the display apparatus may further include a camera. A user's motion may be recognized from an image photographed by the camera. Herein, if the user's motion is a motion to search for an electronic apparatus, a control signal may be transmitted to the electronic apparatus.

Below is a description regarding another exemplary embodiment of controlling an electronic apparatus using a display apparatus.

Specifically, the display apparatus may capture an image of a user or an object. If a search command is included in a user's voice, a control signal may be transmitted to the electronic apparatus. In this case, the location of the electronic apparatus may be estimated by analyzing an image which is captured at a time when the display apparatus was last used, a UI message indicating the estimated location of the electronic apparatus may be displayed.

Below is a description regarding another exemplary embodiment of controlling an electronic apparatus using a display apparatus.

Location information is received from a control apparatus. In this case, if a search command is included in a user's voice, a control signal is transmitted to the electronic apparatus. Herein, the location of the electronic apparatus is estimated based on the location information, and a UI message indicating the estimated location may be displayed.

There may be other exemplary embodiments of controlling an electronic apparatus using a display apparatus.

Specifically, if a control command to control the external electronic apparatus is included in a user's voice, a control signal corresponding to the control command may be transmitted to the external electronic apparatus. The operation thereof has already been described above with reference to FIG. 7, so further description will not be provided.

The foregoing exemplary embodiments and advantages are merely exemplary and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A display apparatus, comprising:
a microphone configured to receive a voice signal;
a voice recognizer configured to recognize a user's voice from the received voice signal;
a communicator configured to communicate with an electronic apparatus;
a storage configured to store information regarding a search command to search for the electronic apparatus; and
a controller configured to, when the search command is included in the user's voice, control to transmit a control signal to the electronic apparatus through the communicator, requesting the electronic apparatus to generate a feedback signal.

2. The apparatus as claimed in claim 1, wherein the microphone and the voice recognizer remain in an active state when the display apparatus is turned off,
wherein the controller, in response to the user's voice being recognized by the voice recognizer while the display apparatus is turned off, is configured to determine whether the search command is included in the user's voice, and when the search command is included in the user's voice, activate the communicator to transmit the control signal to the electronic apparatus.

3. The apparatus as claimed in claim 2, wherein the controller is configured to, in response to a control command to control the display apparatus being included in the user's voice, turn on the display apparatus and perform a control operation corresponding to the control command.

4. The apparatus as claimed in claim 1, wherein the communicator performs communication with the electronic apparatus according to one of WiFi and Bluetooth communication methods.

5. The apparatus as claimed in claim 1, further comprising:
at least one button,
wherein the controller is configured to, in response to the at least one button being selected, execute a function corresponding to the button, and when the button is selected more than a predetermined number of times for a predetermined time period, transmit the control signal to the electronic apparatus through the communicator.

6. The apparatus as claimed in claim 1, further comprising:
a camera; and
a motion recognizer configured to recognize a user's motion from an image photographed by the camera,
wherein the controller, when the user's motion is a motion to search for the electronic apparatus, transmits the control signal to the electronic apparatus.

7. The apparatus as claimed in claim 1, further comprising:
a display; and
a camera configured to perform photographing,
wherein the controller is configured to, in response to the search command being included in the user's voice, transmit the control signal to the electronic apparatus,
wherein the controller estimates a location of the electronic apparatus by analyzing an image photographed a last time the display apparatus was used, and displays a user interface (UI) message indicating the estimated location of the electronic apparatus on the display.

8. The apparatus as claimed in claim 1, further comprising:
a display,
wherein the communicator is configured to receive location information from the electronic apparatus,
wherein the controller is configured to, in response to the search command being included in the user's voice, transmit the control signal to the electronic apparatus, and
wherein the controller is configured to estimate a location of the electronic apparatus by analyzing an image photographed a last time the display apparatus was used, and displays a user interface (UI) message indicating the estimated location of the electronic apparatus on the display.

9. The apparatus as claimed in claim 1, wherein the controller is configured to, in response to a control command to control an external electronic apparatus being included in the user's voice, transmit a control signal corresponding to the control command to the external electronic apparatus through the communicator.

10. A method for controlling an electronic apparatus by a display apparatus, the method comprising:
receiving a voice signal;
recognizing a user's voice from the received voice signal; and
when a search command is included in the recognized user's voice, transmitting a control signal to the electronic apparatus requesting the electronic apparatus to generate a feedback signal.

11. The method as claimed in claim 10, wherein the receiving a voice signal and the recognizing the user's voice comprise, when the display apparatus is in an active state while the display apparatus is turned off, and the user's voice is recognized while the display apparatus is turned off, determining whether the search command is included in the user's voice, and when the search command is included in the user's voice, transmitting the control signal to the electronic apparatus.

12. The method as claimed in claim 11, comprising:
when a control command to control the display apparatus is included in the user's voice, turning on the display apparatus and performing a control operation corresponding to the control command.

13. The method as claimed in claim 10, comprising:
performing communication with the electronic apparatus according to one of WiFi and Bluetooth communication methods.

14. The method as claimed in claim 10, wherein the display apparatus further includes at least one button,
the method comprising:
when the at least one button is selected, executing a function corresponding to the button, and when the button is selected more than a predetermined number of times for a predetermined time period, transmitting the control signal to the electronic apparatus through the communicator.

15. The method as claimed in claim 10, wherein the display apparatus further comprises a camera,
the method comprising:
recognizing a user's motion from an image photographed by the camera; and
in response to the user's motion being a motion to search for the electronic apparatus, transmitting the control signal to the electronic apparatus.

16. The method as claimed in claim 10, further comprising:
performing a photographing process;
when the search command is included in the user's voice, transmitting the control signal to the electronic apparatus; and
estimating a location of the electronic apparatus by analyzing an image photographed when the display apparatus was last used, and displaying a user interface (UI) message indicating the estimated location of the electronic apparatus.

17. The apparatus as claimed in claim 1, wherein the electronic apparatus is a remote controller.

18. A method for controlling at least one external apparatus by a display apparatus, the method comprising:
receiving a voice signal at the display device;
recognizing a user's voice from the received voice signal;
determining whether a control command to control the at least one external apparatus is included in the recognized user's voice; and
transmitting the control command to the at least one external apparatus when the control command is included in the recognized user's voice.

19. The method of claim 18, wherein the control command is a command to power on or power off the at least one external apparatus.

20. The method of claim 18, wherein the control command is a command to update software or firmware of the at least one external apparatus.
